(19) United States
(12) Patent Application Publication
(10) Pub. No.: US 2023/0079897 A1
(43) Pub. Date: Mar. 16, 2023

(54) INFORMATION PROCESSING APPARATUS, INFORMATION PROCESSING METHOD, AND COMPUTER READABLE RECORDING MEDIUM

(71) Applicant: NEC Corporation, Minato-ku, Tokyo (JP)

(72) Inventors: Manao Machida, Tokyo (JP); Masumi Ichien, Tokyo (JP)

(73) Assignee: NEC Corporation, Minato-ku, Tokyo (JP)

(21) Appl. No.: 17/800,703

(22) PCT Filed: Feb. 25, 2020
(86) PCT No.: PCT/JP2020/007505

§ 371 Date: Aug. 18, 2022

(51) Int. Cl. G06Q 10/06

(52) U.S. Cl. CPC G06Q 10/06311

(57) ABSTRACT

Information processing apparatus includes: an observation unit that observes situations and speeds of agents; a task weight estimation unit that estimates second task weights with reference to a first model based on the observed positions, the observed speeds, and first task weights indicating set execution probabilities of tasks by the agents, the second task weights indicating execution probabilities of the tasks by the agents under the observed statuses; and a task weight update unit that updates the first task weights by inputting the observed positions, the observed speeds, and the second task weights to a second model. When one of a position and a speed has been input together with a weight coefficient, the first model outputs the other of the position and the speed. The second model increases a value of a first weight as a cost calculated using a position, a speed, and a second task weight decreases.

### TECHNICAL FIELD

The present invention relates to an information processing apparatus and an information processing method for realizing coordinated operations among agents in a multi-agent system, and further to a computer readable recording medium that includes a program recorded thereon, the program being intended to realize the apparatus and the method.

### BACKGROUND ART

A system that causes a plurality of agents to operate in coordination with one another is called a multi-agent system. In a multi-agent system, each agent determines its own actions based on information that has been observed by a sensor included in itself, and on information that has been obtained from another agent located nearby via local communication. Also, while typical examples of agents in a multi-agent system are autonomously traveling robots, the agents may include humans.

Patent document 1 discloses one example of a multi-agent system. The multi-agent system disclosed in patent document 1 adopts a method in which a plurality of robots select, from among a plurality of tasks, a task that is to be executed autonomously. Specifically, according to this method, each robot declares a cost incurred in executing a task by itself on a per-task basis. Consequently, the multi-agent system assigns each task to a robot that declared the lowest cost regarding the task. This method is called auction-based task assignment due to its feature that a price (cost) is declared and a product (task) is bid on.

### LIST OF RELATED ART DOCUMENTS

### Patent Document

Patent document 1: Japanese Patent Laid-Open Publication No. 2007-52683

### SUMMARY OF INVENTION

### Problems to be Solved by the Invention

In the multi-agent system disclosed in patent document 1, as task assignment is conducted based on inter-robot communication, it may be difficult to conduct task assignment due to the occurrence of a situation where communication cannot be performed, or a situation where it is difficult to perform communication, depending on the environment in which the multi-agent system operates.

For example, in the environment in which humans coexist as agents in addition to robots, while communication can be performed among robots, communication cannot be normally performed between robots and humans. Therefore, in the multi-agent system disclosed in patent document 1, task assignment is impossible in the environment in which robots and humans coexist. Furthermore, when different communication protocols are used, communication cannot be performed even among robots. In this case, too, task assignment is impossible.

In addition, in a situation where a large number of other systems have already been performing communication, there are cases where the communication bands are occupied, and the communication between robots, which is possible in normal situation, is not possible, or the communication delay increases. In this case, too, it is difficult to conduct task assignment.

Especially, the problem with task assignment under a no-communication environment is that, within the multi-agent system, adjustment regarding which agent (robot or human) is planning to execute which task is not possible. When adjustment is not achieved, a situation may occur where a plurality of agents is directed toward a task that is sufficient to be executed by one agent, and other tasks cannot be achieved.

An example object of the present invention is to solve the aforementioned problem, and provide an information processing apparatus, an information processing method, and a computer readable recording medium that can assist the assignment of tasks to respective agents in a multi-agent system under a no-communication environment.

### SUMMARY OF INVENTION

### Problems to be Solved by the Invention

In order to achieve the above-described object, an information processing apparatus assists assignment of tasks to a plurality of agents in a multi-agent system in which the agents are caused to operate, the information processing apparatus includes:

an observation unit that observes situations of the agents, including positions and speeds of the agents;

a task weight estimation unit that estimates second task weights with reference to a first model based on the observed positions, the observed speeds, and first task weights, the first task weights indicating set values of execution probabilities of tasks by the agents, the second task weights indicating execution probabilities of the tasks by the agents under the observed statuses; and

a task weight update unit that updates the first task weights by inputting the observed positions, the observed speeds, and the estimated second task weights to a second model, wherein the first model is a model that, when one of a position and a speed has been input together with a weight coefficient, outputs the other of the position and the speed, and the second model is a model that increases a value of a first weight as a cost calculated using a position, a speed, and a second task weight decreases.

In addition, in order to achieve the above-described object, an information processing method assists assignment of tasks to a plurality of agents in a multi-agent system in which the agents are caused to operate, the information method includes:

observing situations of the agents, including positions and speeds of the agents;

estimating second task weights with reference to a first model based on the observed positions, the observed speeds, and first task weights, the first task weights indicating set values of execution probabilities of tasks by the agents, the second task weights indicating execution probabilities of the tasks by the agents under the observed situations; and

updating the first task weights by inputting the observed positions, the observed speeds, and the estimated second task weights to a second model,

wherein

the first model is a model that, when one of a position and a speed has been input together with a weight coefficient, outputs the other of the position and the speed, and the second model is a model that increases a value of a first weight as a cost calculated using a position, a speed, and a second task weight decreases.

Furthermore, in order to achieve the above-described object, a computer readable recording medium according to an example aspect of the invention is a computer readable recording medium that includes recorded thereon a program, the program being intended to cause a computer to assist assignment of tasks to a plurality of agents in a multi-agent system in which the agents are caused to operate,

wherein the recorded program includes instructions that cause the computer to

observe situations of the agents, including positions and speeds of the agents,

estimate second task weights with reference to a first model based on the observed positions, the observed speeds, and first task weights, the first task weights indicating set values of execution probabilities of tasks by the agents, the second task weights indicating execution probabilities of the tasks by the agents under the observed situations, and

update the first task weights by inputting the observed positions, the observed speeds, and the estimated second task weights to a second model,

the first model is a model that, when one of a position and a speed has been input together with a weight coefficient, outputs the other of the position and the speed, and

the second model is a model that increases a value of a first weight as a cost calculated using a position, a speed, and a second task weight decreases.

### Advantageous Effects of the Invention

As described above, according to the invention, it is possible to assist the assignment of tasks to respective agents in a multi-agent system under a no-communication environment.

### BRIEF DESCRIPTION OF THE DRAWINGS

FIG. 1 is a block diagram illustrating a schematic configuration of a information processing apparatus in the first example embodiment.

FIG. 2 is a block diagram specifically illustrating the configuration of the information processing apparatus in the first example embodiment.

FIG. 3 is a diagram illustrating examples of tasks executed by respective agents in the first example embodiment.

FIG. 4 is a flow diagram illustrating the operations of the information processing apparatus in the first example embodiment.

FIG. 5 is a block diagram specifically illustrating the configuration of an example modification of the information processing apparatus in the first example embodiment.

FIG. 6 is a block diagram illustrating the configuration of the information processing apparatus in the second example embodiment.

FIG. 7 is a flow diagram illustrating the operations of the information processing apparatus in the second example embodiment.

FIG. 8 is a block diagram illustrating an example of a computer that realizes the information processing apparatus according to the first and second example embodiment.

### EXAMPLE EMBODIMENTS

### First Example Embodiment

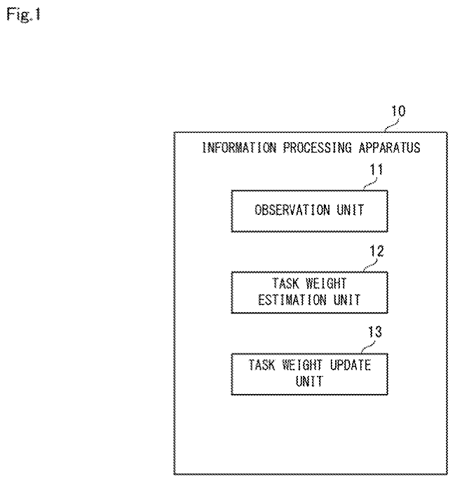

The following describes an information processing apparatus, an information processing method, and a program in a first example embodiment with reference to FIG. 1 to FIG. 5.

[Apparatus Configuration]

First, a schematic configuration of the information processing apparatus in the first example embodiment will be described using FIG. 1. FIG. 1 is a block diagram illustrating the schematic configuration of the information processing apparatus in the first example embodiment.

The information processing apparatus 10 in the first example embodiment illustrated in FIG. 1 is an apparatus that assists the assignment of tasks to agents in a multi-agent system in which agents are caused to operate. With the information processing apparatus 10, coordinated operations among agents can be realized in the multi-agent system.

As illustrated in FIG. 1, the information processing apparatus 10 includes an observation unit 11, a task weight estimation unit 12, and a task weight update unit 13. With this configuration, the observation unit 11 observes the situation of an agent, including the position and speed of the agent.

Based on the observed position, the observed speed, and a first task weight indicating a set value of the execution probability of a task by the agent, the task weight estimation unit 12 refers to a first model, and estimates a second task weight indicating the execution probability of the task by the agent under the observed situation. The first model is a model that, when one of the position and the speed has been input together with a weight coefficient, outputs the other of the position and the speed.

The task weight update unit 13 updates the first task weight by inputting the observed position, the observed speed, and the estimated second task weight to a second model. The second model is a model that increases the value of the first weight as the cost calculated using the position, speed, and second task weight decreases.

In this way, in the first example embodiment, the situation of an agent is observed, and the second task weight indicating whether the agent is planning to actually execute a task is estimated with use of the observed situation. Therefore, in the first example embodiment, even under a no-communication environment, each agent can judge which task is to be executed by another agent, thereby rendering coordination possible in the multi-agent system. That is to say, according to the first example embodiment, assignment of tasks to respective agents can be assisted in the multi-agent system under a no-communication environment.

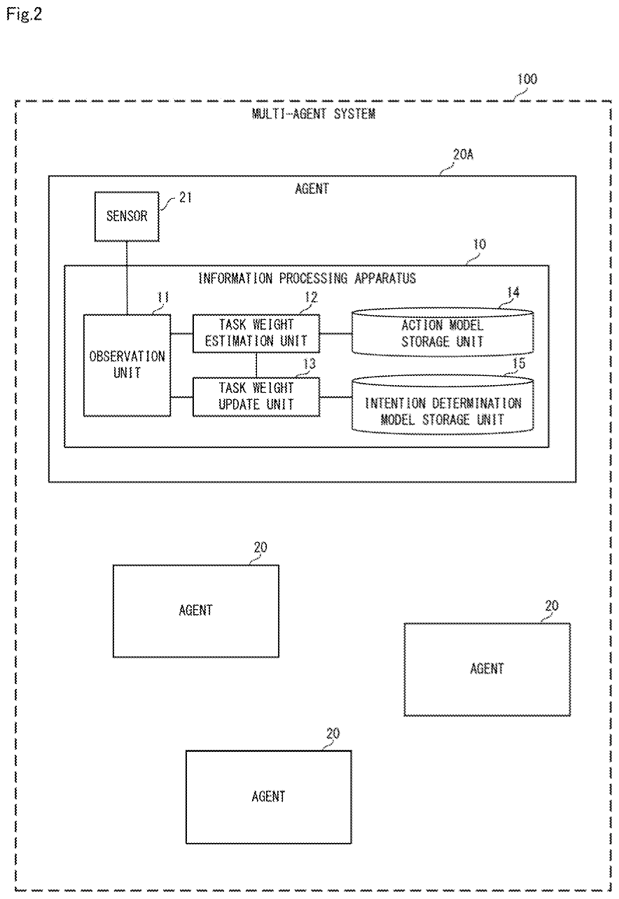

Subsequently, the configuration and functions of the information processing apparatus in the first example embodiment will be specifically described using FIG. 2 to FIG. 5. FIG. 2 is a block diagram specifically illustrating the configuration of the information processing apparatus in the first example embodiment.

First, as illustrated in FIG. 2, in the first example embodiment, a plurality of agents 20 is included in a multi-agent system 100. Examples of the agents 20 include autonomously traveling robots, and also humans. The information processing apparatus 10 is mounted on a specific agent that constitutes the multi-agent system 100, that is to say, one autonomously traveling robot.

Below, the specific agent on which the information processing apparatus 10 is mounted will be denoted by “20A”. Furthermore, the following description will be provided with a focus on a situation where the information processing apparatus 10 mounted on one agent 20 assists the assignment of a task executed by another one agent 20.

As illustrated in FIG. 2, in the first example embodiment, the information processing apparatus 10 includes an observation unit 11, a task weight estimation unit 12, a task weight update unit 13, an action model storage unit 14, and an intention determination model storage unit 15.

The observation unit 11 observes a situation with respect to another agent 20 other than the specific agent 20A on which the information processing apparatus 10 is mounted. The task weight estimation unit 12 estimates a second task weight with respect to another agent 20. The task weight update unit 13 updates a first task weight with respect to this agent 20. Note that if the information processing apparatus 10 according to the first example embodiment is in a mode where it executes processing for each of other agents 20, the information processing apparatus 10 mounted on one agent 20A can assist the assignment of tasks that are respectively executed by the plurality of agents 20.

In the first example embodiment, the observation unit 11 observes the position x(t) and the speed v(t) of another agent 20 at each time t. Specifically, the observation unit 11 obtains sensor data from a sensor 21, which is a camera, Lider, or the like, and calculates the position x(t) and the speed v(t) based on the obtained sensor data. Also, the observation unit 11 may calculate the speed using a sensor that can directly observe the speed, or may calculate the speed from a change in position information of the agent. In this case, provided that the observation interval is Δt, the observation unit 11 calculates the speed v(t+Δt)(=(x(t+Δt)−x(t))/Δt) from the position x(t) at time t and the position x(t+Δt) at the next time of observation (where “/” denotes division).

The task weight estimation unit 12 refers to an action model based on the position and the speed of another agent 20 observed by the task weight observation unit 12 and on the first task weight that has already been updated by the task weight update unit 13, and estimates the second task weight of this agent 20.

Here, the first task weight and the second task weight will be described. The first task weight and the second task weight both indicate the extent to which an agent 20 is planning to execute each task, and indicate the execution probability of the task. Note that the first task weight is a set value. On the other hand, the second task weight is an estimated value that is estimated from the observed situation of the agent.

Also, it is assumed that the first task weight and the second task weight are both denoted by “α”. Furthermore, for example, provided that there are task 1, task 2, and task 3, and that the task weights of the respective tasks are α₁, α₂, and α₃, the following Math. 1 holds.

$$( {α}_{1} , {α}_{2} , {α}_{3} ) = ( \frac{1}{2} , \frac{1}{3} , \frac{1}{6} ) \qquad [ Math . 1 ]$$

The above Math. 1 indicates that the agent 20 executes task 1, task 2, and task 3 with a probability of 1/2, 1/3, and 1/6, respectively. Formally, the task weight estimation unit 12 uses the first model with input values of the position, the speed, and the first task weight (set value) α-hat of another agent 20, and outputs the second task weight (estimated value) α-breve indicated by the following Math. 2.

\check{α}(t)=H(x(t),v(t),\hat{α} [Math. 2]

The task weight update unit 13 inputs the position and the speed of another agent 20 observed by the observation unit 11, as well as the second task weight estimated by the task weight estimation unit 12, to the second model. Then, the task weight update unit 13 predicts the task weight at the next time, which indicates the determination of intention of this agent 20, from the output result of the second model, and updates the first weight based on the predicted value.

Formally, the task weight update unit 13 inputs the position x(t) and the speed v(t) observed by the observation unit 11 and the second task weight (estimated value) α-breve estimated by the task weight estimation unit 12 to an intention determination model. The task weight update unit 13 predicts the first task weight (α-hat (t+Δt)) at the next time, which is indicated by the following Math. 3.

\hat{α}(t+Δt)=G(\check{α}(t),x(t),v(t)) [Math. 3]

Also, the task weight update unit 13 can input not only the current position and speed of another agent 20 and the second task weight described above, but also the past history thereof, to the intention determination model.

The action model storage unit 14 stores the first model (hereinafter referred to as an “action model”). The action model may be transmitted from another agent 20 in advance, or may be constructed by predicting the actions of another agent. Specifically, in the first example embodiment, the action model is a rule that determines the speed of the agent 20 in various situations. Formally, the action model is, for example, a function F shown in the following Math. 4, which uses the task weight and the position as inputs and outputs the speed.

v(t)=F(α(t),x(t)) [Math. 4]

The intention determination model storage unit 15 stores the second model (hereinafter referred to as an “intention determination model”). The intention determination model is a model indicating how the agent 20 updates its own task weight in accordance with a situation. Formally, a later-described function G used in the task weight update unit 13 corresponds to the intention determination model.

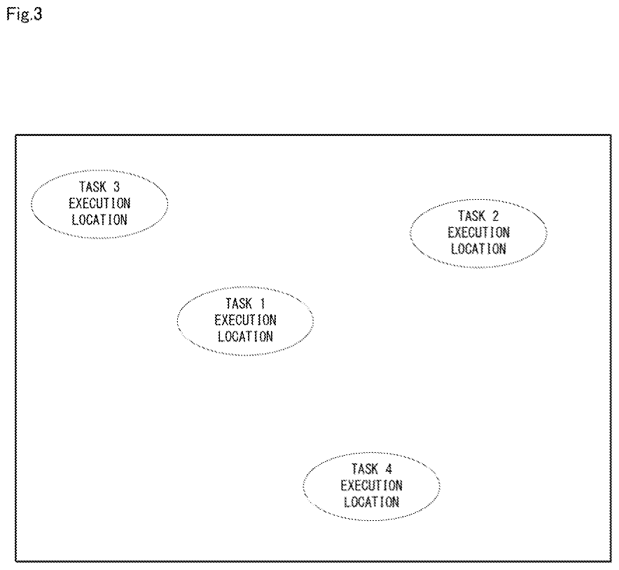

Here, the functions of the task weight estimation unit 12 and the task weight update unit 13 will be described in detail with use of FIG. 3, using specific examples of the action model and the intention determination model. FIG. 3 is a diagram illustrating examples of tasks executed by respective agents in the first example embodiment.

In the first example embodiment, processing and advantageous effects of the system will be described using the specific action model, intention determination model, and task weight estimation method as examples. First, assume a situation where a plurality of task execution locations is situated at different locations as illustrated in FIG. 3. Assume that a set of tasks is M=(1, . . . , m), and the execution position of task j is yⱼ.

First, the action model storage unit 14 stores an artificial force field control model, which is widely used in the field of control, as the action model. That is to say, the action model storage unit 14 stores a function F indicated by the following Math. 6 as the action model.

$$P ( α , x ) = {{\sum }_{j = 1}}^{m} {α}_{j} {‖ {y}_{j} - x ‖}^{2} \qquad [ Math . 5 ]$$

$$F ( α , x ) = - \frac{\partial P}{\partial x} ( α , x ) \qquad [ Math . 6 ]$$

In the artificial force field control model, first, a potential function P is set as indicated by Math. 5. In the present issue, this potential function P corresponds to the expected value of the cost of execution of the tasks. The cost of execution of task j is the square of the distance between the execution position of task j and the agent 20, and the expected value is calculated by multiplying the cost by the task weight (execution probability) αⱼ of task j, and calculating the total sum of the multiplication values for the respective tasks. Then, as indicated by Math. 6, the function F determines the speed in the direction in which the function P (cost) decreases.

The intention determination model storage unit stores replicator dynamics, which are one of the rational methods of updating strategies in a game theory, as the intention determination model. That is to say, the intention determination model storage unit stores a function G indicated by the following expression 7 as the intention determination model.

\hat{α}ⱼ(t+Δt)=Gⱼ(\check{α}, x,v)=\check{α}ⱼ−\check{α}ⱼΔt(∥yⱼ−x∥²−P(\check{α},x)) [Math. 7]

One property of replicator dynamics is to increase the probability of execution of a task with a cost lower than the current expected cost P (α-breve, x). Therefore, replicator dynamics are a rational intention determination model that plans to execute a task with a lower cost. As the task weight update unit 13 simply performs processing by using the function G stored in the intention determination model storage unit as is, a description thereof is omitted here.

The task weight estimation unit 12 specifies a weight coefficient that does not contradict the observed position and the observed speed from the action model, and estimates the second task weight based on the result of comparison between the specified weight coefficient and the first task weight.

Specifically, the task weight estimation unit 12 uses the function F stored in the action model storage unit 14 as the action model. The function F outputs a weight coefficient that is closest to the first task weight (set value) α-hat among the tasks that do not contradict the action model as the second task weight (estimated value). A task weight that does not contradict the action model refers to a task weight α that satisfies the following Math. 8 with respect to the observed position x(t) and speed v(t) and the function F.

(α,x(t))∈F⁻¹(v(t)) [Math. 8]

Here, F⁻¹ is the inverse function of the function F. In reference to the function F that serves as the action model, only the weight coefficient a with which the observed speed v(t) is output satisfies the above Math. 8.

Next, the task weight estimation unit 12 selects a weight which satisfies the constraints, and which is closest to the first task weight (set value) α-hat as the second task weight (estimated value). With respect to the function F in the first example embodiment, the second task weight (estimated value) obtained in the aforementioned procedure is derived using, for example, a function H indicated by the following Math. 9 and Math. 10. In the following Math. 10, A⁺ is a pseudo inverse matrix of a matrix A.

A=[2(x−y₁) . . . 2(x−yₘ)] [Math. 9]

H(x(t),v(t),\hat{α})=−A⁺v(t)+(I−A⁺A)\hat{α} [Math. 10]

As described above, in the first example embodiment, first, a weight coefficient that does not contradict the action model is specified, and consequently, the second task weight of another agent is estimated with certain or higher accuracy. For example, when there are only two tasks, the second task weight that matches a true task weight is estimated in most cases. For example, when the following Math. 11 holds, the following Math. 12 is true, and an inverse matrix is derived. In the following Math. 11, x denotes the position of an agent, and y denotes the position at which a task is executed.

$$x = [ \begin{matrix}1 \\ 2\end{matrix} ] , {y}_{1} = [ \begin{matrix}3 \\ 2\end{matrix} ] , {y}_{2} = [ \begin{matrix}0 \\ 3\end{matrix} ] \qquad [ Math . 11 ]$$

$$A = [ \begin{matrix}- 4 & 2 \\ 0 & - 2\end{matrix} ] \qquad [ Math . 12 ]$$

Therefore, with use of the following Math. 13, the second task weight (estimated value) is uniquely determined without relying on the first task weight (set value), and matches a true value. Therefore, coordinated operations of the plurality of agents 20 can be realized by assigning tasks to respective agents 20 with use of the second task weights estimated by the information processing apparatus 10.

$$H ( x ( t ) , v ( t ) , \hat{α} ) = [ \begin{matrix}0.25 & 0.25 \\ 0 & 0.5\end{matrix} ] v ( t ) \qquad [ Math . 13 ]$$

Furthermore, assume that there are three or more tasks as illustrated in FIG. 3, and an agent is remaining at the execution location of task 1, for example. In this case, without the first task weight (set value), it is impossible to judge whether this agent is planning to execute task 1, or is remaining at the execution location of task 1 in order to execute tasks 2, 3, and 4 with equal probabilities.

However, in the first example embodiment, the rationality of an agent 20 is assumed, and updating the first task weight (set value) causes the second task (estimated value) to be updated as well. Therefore, the agent 20 situated at the execution location of task 1 can execute task 1 at the lowest cost. In this case, the value of the second task (estimated value) α₁-breve gradually increases, and a third party can judge that this agent is planning to execute task 1. Thus, in the first example embodiment, the irrational estimation indicating that an agent keeps planning to execute a high-cost task with the same probability is eliminated.

[Apparatus Operations]

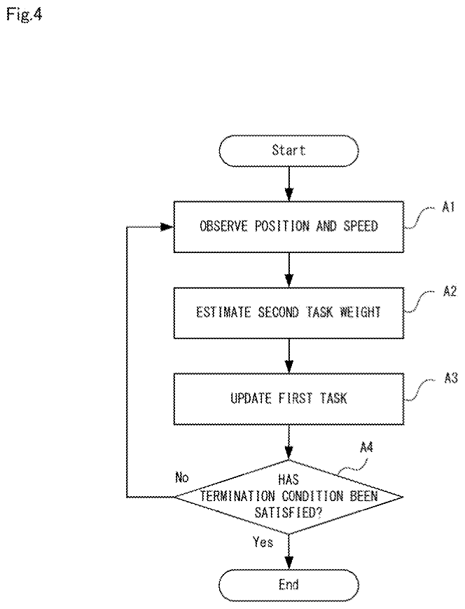

Next, the operations of the information processing apparatus 10 in the first example embodiment will be described using FIG. 4. FIG. 4 is a flow diagram illustrating the operations of the information processing apparatus in the first example embodiment. In the following description, FIG. 1 to FIG. 3 will be referred to as appropriate. Also, in the first example embodiment, the information processing method is implemented by causing the information processing apparatus 10 to operate. Therefore, the following description of the operations of the information processing apparatus 10 applies to the information processing method in the first example embodiment.

As illustrated in FIG. 2, first, in the information processing apparatus 10, the observation unit 11 observes the position and speed of another agent 20 based on sensor data from the sensor 21 (step A1).

Next, with reference to the first model, the task weight estimation unit 12 estimates a second task weight based on the position and speed observed in step A1 and a first task weight (step A2). As stated earlier, the first task weight is a weight indicating a set value of the execution probability of a task by another agent 20. The second task weight is a weight indicating the execution probability of the task by this agent 20 under the observed situation.

Also, in step A2, in a case where later-described step A3 has not been executed yet, an initial value that has been set in advance is used as the first task weight. An example of the initial value is (0, . . . , 0). Furthermore, in a case where later-described step A3 has already been executed, the value that was updated in step A3 most recently is used as the first task weight.

Subsequently, the task weight update unit 13 inputs, to the intention determination model, the position and speed of another agent 20 that were observed in step A1, as well as the second task weight that was estimated in step A2. Then, with use of the result of output of the intention determination model, the task weight update unit 13 predicts the first task, and updates the first task based on the predicted value (step A3).

Thereafter, the task weight update unit 13 determines whether a termination condition has been satisfied (step A4). In a case where the result of determination in step A4 shows that the termination condition has not been satisfied (step A4: NO), the task weight update unit 13 cause the observation unit 11 to execute step A1 again. Furthermore, steps A2 and A3 are also executed again. Note that in step A2 of this case, the first task weight that was updated in previous step A4 is used. On the other hand, in a case where the result of determination in step A4 shows that the termination condition has been satisfied (step A4: YES), processing in the information processing apparatus 10 is terminated.

No particular restriction is placed on the termination condition in step A4. An example of the termination condition is a condition where the task weight has not undergone a change that exceeds a threshold in the agent 20 within a certain time period until the current time. Such a termination condition corresponds to a condition where, based on the prediction that the task weight has not changed because task assignment has been achieved, the achievement of task assignment is estimated and updating of the task weight is terminated.

In the above-described manner, in the first example embodiment, steps A1 to A3 are repeatedly executed within a short span while the multi-agent system 100 is in operation. Therefore, processing for estimating the second task weight and processing for updating the first task weight are repeated in a feedback fashion while using the output of one processing as the input to the other processing, and the values of both task weights are updated.

[Program]

It suffices for a program in the first example embodiment of the invention to be a program that causes a computer to carry out steps A1 to A4 illustrated in FIG. 4. Also, by this program being installed and executed in the computer, the information processing apparatus 10 and the information processing method according to the first example embodiment can be realized. In this case, a processor of the computer functions and performs processing as the observation unit 11, the task weight estimation unit 12, and the task weight update unit 13. Examples of the computer include a computer mounted on a robot serving as the agent 20, but also a general-purpose PC (Personal Computer), a smartphone, a tablet terminal device, and the like.

Also, the action model storage unit 14, and the intention determination model storage unit 15 may be realized by storing a data file constituting them into a storage device, such as a hard disk, included in the computer, or may be realized by a storage device of other computer that is different from the computer.

Furthermore, the program according to the first example embodiment may be executed by a computer system constructed with a plurality of computers. In this case, for example, each computer may function as one of the observation unit 11, the task weight estimation unit 12, and the task weight update unit 13.

[Example Modification]

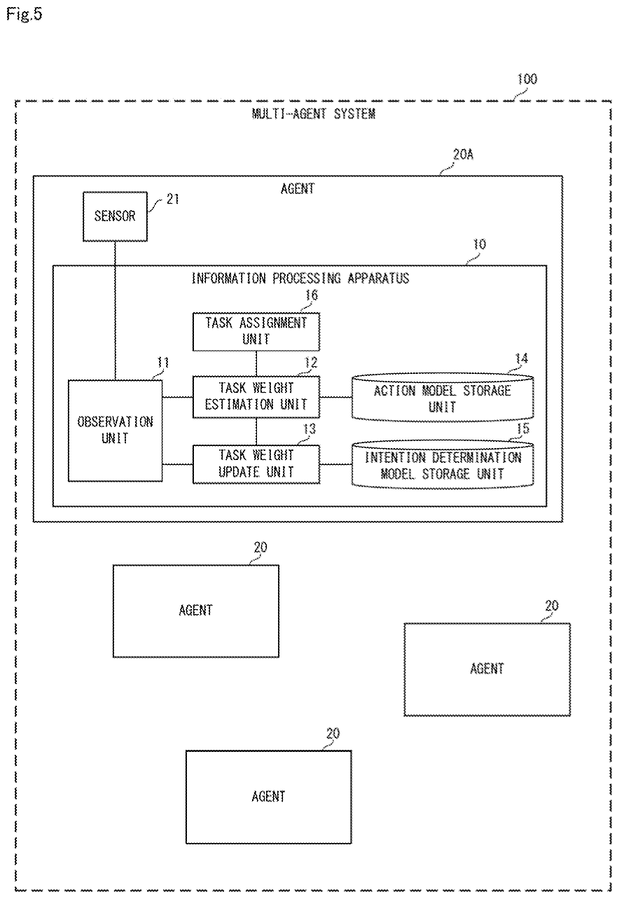

A description is now given of an example modification of the first example embodiment with use of FIG. 5. FIG. 5 is a block diagram specifically illustrating the configuration of an example modification of the information processing apparatus in the first example embodiment. As illustrated in FIG. 5, in the present example modification, the information processing apparatus 10 includes an observation unit 11, a task weight estimation unit 12, a task weight update unit 13, an action model storage unit 14, an intention determination model storage unit 15, and a task assignment unit 16.

The task assignment unit 16 calculates the costs of respective tasks performed in the multi-agent system, and assigns a task to a specific agent 20A based on the respective costs that have been calculated and the second weights that have been estimated with respect to other agents 20. Below is a specific description of task assignment processing.

It is assumed that speed control for robots, namely the agents 20, conforms to an artificial force field control model F. The task weight of a robot itself is updated based on the following Math. 14, a set of other agents 20 being denoted as L={1, . . . ,1}.

$${\dot{α}}_{l} = 1 - {\sum }_{k ∈ L} {i}_{k}^{} + 1 - {\sum }_{j ∈ M} {α}_{j} - s {‖ {y}_{i} - x ‖}^{2} \qquad [ Math . 14 ]$$

Furthermore, it is assumed that each term of the above Math. 14 is defined as in the following Math. 15 to Math. 17.

$$Q = 1 - {\sum }_{k ∈ L} {i}_{k}^{} \qquad [ Math . 15 ]$$

$$R = 1 - {\sum }_{j ∈ M} {α}_{j} \qquad [ Math . 16 ]$$

$$S = s {‖ {y}_{i} - x ‖}^{2} ( s > 0 ) \qquad [ Math . 17 ]$$

In the above Math. 14, Q indicated by the above Math. 15 corresponds to processing in which, if the probability that task i is performed by the whole system including the robot itself and other agents is low, then the probability that the robot itself performs task i is increased. In the above Math. 14, R indicated by the above Math. 16 corresponds to processing for bringing the sum of task weights of itself close to 1. Finally, in the above Math. 14, S indicated by the above Math. 17 corresponds to processing for reducing the probability of execution of a task that is higher in cost of execution.

The task assignment unit 16 updates the task weight a in accordance with the above Math. 14, thereby assigning a specific agent 20A a task which is included among the tasks that other agents are not planning to execute and which is lower in cost, and causing the specific agent 20A to execute this one task. Therefore, in the present first example embodiment, assignment of tasks to agents is achieved.

### Second Example Embodiment

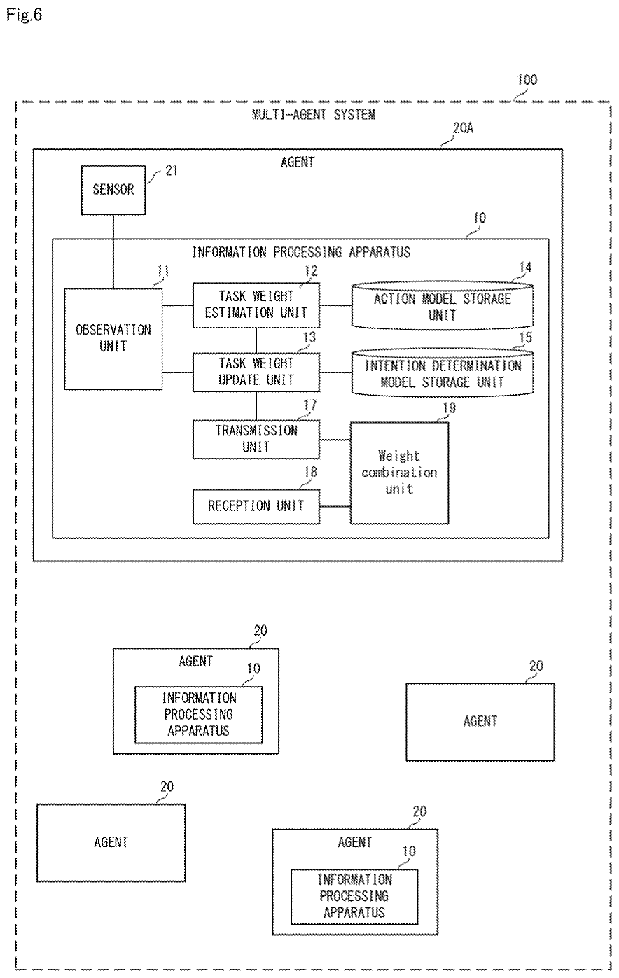

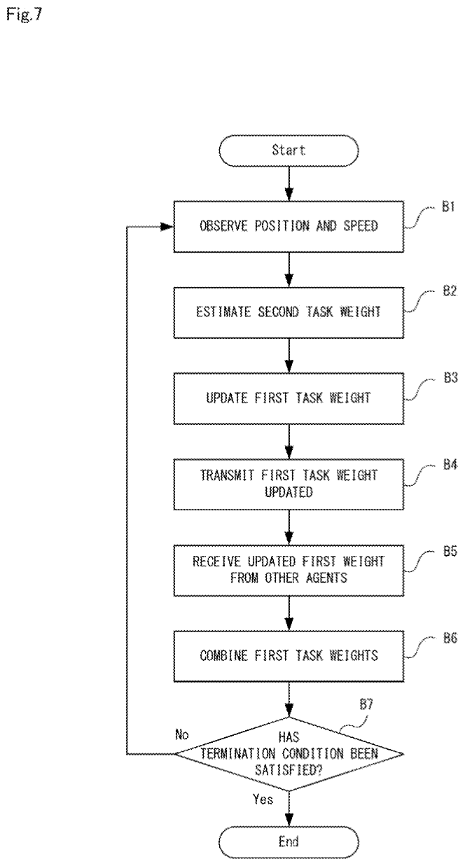

Next, an information processing apparatus, an information processing method, and a program in a second example embodiment will be described with reference to FIG. 6 and FIG. 7.

The second example embodiment will be described with regard to a configuration in which a multi-agent system efficiently estimates the task weights of other agents. In the first example embodiment, each robot, namely an agent, cannot achieve task assignment unless it estimates the task weights of all other agents that cannot perform communication. In contrast, according to the second example embodiment, in the multi-agent system, respective agents that can perform communication collaboratively estimate the task weights of other agents that cannot perform communication.

[Apparatus Configuration]

First, the configuration of the information processing apparatus in the second example embodiment will be described using FIG. 6. FIG. 6 is a block diagram illustrating the configuration of the information processing apparatus in the second example embodiment.

First, as illustrated in FIG. 6, in the second example embodiment, the information processing apparatus 10 is mounted not only on one agent 20, but also on several agents 20. As illustrated in FIG. 6, unlike the example of the first example embodiment illustrated in FIG. 2, the information processing apparatus 10 includes an observation unit 11, a task weight estimation unit 12, a task weight update unit 13, an action model storage unit 14, an intention determination model storage unit 15, a transmission unit 17, a reception unit 18, and a weight combination unit 19. Also, in the example of FIG. 6, functional blocks are illustrated only with respect to one information processing apparatus 10, and the illustration of functional blocks is omitted with respect to other information processing apparatuses.

In the second example embodiment, the observation unit 11 observes the position and the speed only with respect to a designated agent 20 among the agents 20 that are included in the multi-agent system 100. That is to say, in the second example embodiment, the observation unit 11 does not observe all of the agents 20 other than the agent on which the observation unit 11 is mounted but observes only a limited agent 20.

Specifically, the observation unit 11 may observe only an agent 20 that satisfies a set condition, for example, an agent 20 that is located at a distance r or less from the agent on which the observation unit 11 is mounted. Also, the observation unit 11 may observe only an agent 20 that has been assigned in advance. Furthermore, an agent that serves as a target of observation may be observed by the observation units 11 of a plurality of information processing apparatuses. That is to say, one agent may be a target of observation by a plurality of information processing apparatuses 10.

In the second example embodiment, the task weight estimation unit 12 estimates a second task weight with use of the first weights that have been combined by the weight combination unit 19. The functions of the weight combination unit 19 will be described later. Also, the task weight update unit 13 functions similarly to the first example embodiment, and updates the first weight.

The transmission unit 17 transmits the first weight updated by the task weight update unit 13 to other agents 20 which are within the multi-agent system 100 and which can perform communication. The reception unit 18 receives the transmitted, updated first weights from other agents 20.

Using the updated first task weights received by the reception unit 18, the weight combination unit 19 combines the first task weights for each of other agents 20. Also, with respect to the agents 20 for which the first task weights have been updated by the task weight update unit 13 (targets of observation), the weight combination unit 19 combines the first task weights for each of other agents 20 also with use of the first task weights updated by the task weight update unit 13 (the task weights transmitted by the transmission unit 17). The weight combination unit 19 outputs the combined first task weights to, for example, an external apparatus or the task assignment unit 16 described in the above example modification.

Below is a more specific description of combination processing performed by the weight combination unit 19. An example of the combination processing is processing for calculating the average values of respective first task weights. Specifically, assume that the first task weight that was predicted by agent 1 with respect to agent A is α¹-hat, and the first task weight that was predicted by agent 2 with respect to agent A is α²-hat. In this case, the weight combination unit 19 calculates the combined first task weight α-hat based on the following Math. 18.

$$\hat{α} = \frac{1}{2} ( {\hat{α}}^{1} + {\hat{α}}^{2} ) \qquad [ Math . 18 ]$$

With the weight combination unit 19, the information processing apparatus 10 can obtain the first task weight also with respect to another agent that has not been observed thereby. That is to say, once the reception unit 18 has obtained the first weights that have been transmitted from other agents with respect to an unobserved agent, the weight combination unit 19 can combine the received first weights to derive the first weight of the unobserved agent.

For example, assume that, in the above-described example, agent 3 performs neither observation nor estimation of the task weight with respect to agent A. In this case also, agent 3 can derive the first weight of agent A by combining the first task weight α¹-hat received from agent 1 and the first task weight α²-hat received from agent 2.

Furthermore, although not illustrated in FIG. 6, the task assignment unit 16 may be provided also in the second example embodiment, similarly to the example modification of the above-described first example embodiment.

[Apparatus Operations]

Next, the operations of the information processing apparatus 10 in the second example embodiment will be described using FIG. 7. FIG. 7 is a flow diagram illustrating the operations of the information processing apparatus in the second example embodiment. In the following description, FIG. 6 will be referred to as appropriate. Also, in the second example embodiment, the information processing method is implemented by causing the information processing apparatus 10 to operate. Therefore, the following description of the operations of the information processing apparatus 10 applies to the information processing method in the second example embodiment.

As illustrated in FIG. 7, first, in the information processing apparatus 10, the observation unit 11 observes the positions and speeds of other agents 20 that satisfy a set condition, or that have been determined in advance, based on sensor data from the sensor 21 (step B1).

Next, with reference to the first model, the task weight estimation unit 12 estimates the second task weights of other agents 20 that serve as the targets of observation based on the positions and speeds observed in step B1 and the first task weights (step B2).

Also, in step B2, in a case where later-described step B3 or B6 has not been executed yet, initial values that have been set in advance are used as the first task weights. Furthermore, in a case where later-described step B3 or B6 has already been executed, the values that were updated in step B3 or B6 most recently are used as the first task weights.

Next, the task weight update unit 13 inputs, to the intention determination model, the positions and speeds of other agents 20 that were observed in step B1, as well as the second task weights that were estimated in step B2. Then, with use of the result of output of the intention determination model, the task weight update unit 13 predicts the first tasks, and updates the first task weights based on the predicted values (step B3).

Next, the transmission unit 17 transmits the first task weights updated in step B3 to other agents 20 which are within the multi-agent system 100 and which can perform communication (step B4).

Next, the reception unit 18 receives the transmitted, updated first weights from other agents 20 (step B5).

Next, using the first task weights updated in step B3 and the updated first task weights received in step B5, the weight combination unit 19 combines the first task weights for each of other agents 20 (step B6).

Also, in step B6, in a case where the updated first task weights were received in step B5 with respect to an agent 20 that does not serve as the target of observation in step B1, the weight combination unit 19 combines the first task weights also with respect to this agent 20. Furthermore, in step B6, the weight combination unit 19 outputs the combined first task weights to, for example, an external apparatus or the task assignment unit 16 described in the above example modification.

Thereafter, the task weight update unit 13 determines whether a termination condition has been satisfied (step B7). In a case where the result of determination in step B7 shows that the termination condition has not been satisfied (step B7: NO), the observation unit 11 is caused to execute step B1 again. On the other hand, in a case where the result of determination in step B7 shows that the termination condition has been satisfied (step B7: YES), processing in the information processing apparatus 10 is terminated.

As described above, according to the second example embodiment, in the multi-agent system 100, respective agents 20 that can perform communication can collaboratively estimate the task weights of other agents 20 that cannot perform communication.

[Program]

It suffices for a program in the second example embodiment of the invention to be a program that causes a computer to carry out steps B1 to B7 illustrated in FIG. 7. Also, by this program being installed and executed in the computer, the information processing apparatus and the information processing method according to the second example embodiment can be realized. In this case, a processor of the computer functions and performs processing as the observation unit 11, the task weight estimation unit 12, the task weight update unit 13, the transmission unit 17, the reception unit 18, and the weight combination unit 19. Examples of the computer include a computer mounted on a robot serving as the agent 20, but also a general-purpose PC (Personal Computer), a smartphone, a tablet terminal device, and the like.

Also, in the second example embodiment, the action model storage unit 14, and the intention determination model storage unit 15 may be realized by storing a data file constituting them into a storage device, such as a hard disk, included in the computer, or may be realized by a storage device of other computer that is different from the computer.

Furthermore, the program according to the first example embodiment may be executed by a computer system constructed with a plurality of computers. In this case, for example, each computer may function as one of the observation unit 11, the task weight estimation unit 12, the task weight update unit 13, the transmission unit 17, the reception unit 18, and the weight combination unit 19.

[Physical Configuration]

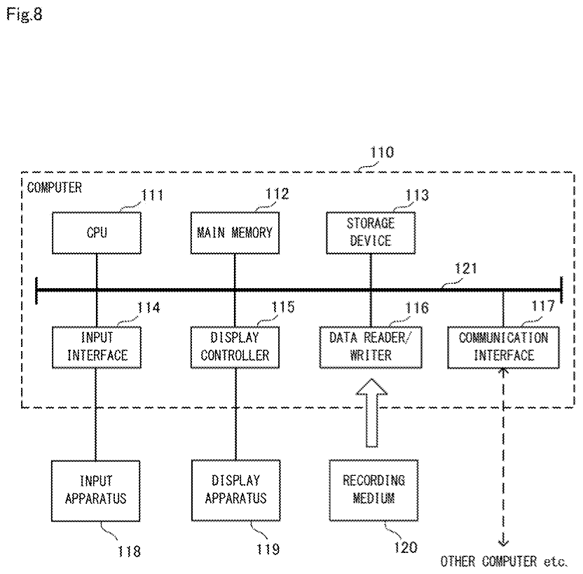

Using FIG. 8, the following describes a computer that realizes the information processing apparatus 10 by executing the program according to the first and second example embodiment. FIG. 8 is a block diagram illustrating an example of a computer that realizes the information processing apparatus according to the first and second example embodiment.

As shown in FIG. 8, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the program in the example embodiment.

The CPU 111 carries out various types of calculation by deploying the program (codes) according to the present example embodiment stored in the storage device 113 to the main memory 112 and executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input apparatus 118, such as a keyboard and a mouse.

The display controller 115 is connected to a display apparatus 119, and controls display on the display apparatus 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the information processing apparatus 10 according to the first and second example embodiment can also be realized by using items of hardware that respectively correspond to the components, rather than the computer in which the program is installed. Furthermore, a part of the information processing apparatus 10 may be realized by the program, and the remaining part of the information processing apparatus 10 may be realized by hardware.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

As described above, according to the invention, it is possible to assist the assignment of tasks to respective agents in a multi-agent system under a no-communication environment. The present invention is useful for a multi-agent system.

### REFERENCE SIGNS LIST

10 Information processing apparatus
11 Observation unit
12 Task weight estimation unit
13 Task weight update unit
14 Action model storage unit
15 Intention determination model storage unit
16 task assignment unit
17 Transmission unit
18 Reception unit
19 Weight combination unit
20 Agent
21 Sensor
100 Multi-agent system
110 Computer
111 CPU
112 Main memory
113 Storage device
114 Input interface
115 Display controller
116 Data reader/writer
117 Communication interface
118 Input apparatus
119 Display apparatus
120 Recording medium
121 Bus

What is claimed is:

1. An information processing apparatus for assisting assignment of tasks to a plurality of agents in a multi-agent system in which the agents are caused to operate, the information processing apparatus comprising:
an observation unit configured to observe situations of the agents, including positions and speeds of the agents;
a task weight estimation unit configured to estimate second task weights with reference to a first model based on the observed positions, the observed speeds, and first task weights, the first task weights indicating set values of execution probabilities of tasks by the agents, the second task weights indicating execution probabilities of the tasks by the agents under the observed statuses; and
a task weight update unit configured to update the first task weights by inputting the observed positions, the observed speeds, and the estimated second task weights to a second model,
wherein
the first model is a model that, when one of a position and a speed has been input together with a weight coefficient, outputs the other of the position and the speed, and
the second model is a model that increases a value of a first weight as a cost calculated using a position, a speed, and a second task weight decreases.

2. The information processing apparatus according to claim 1,
wherein the task weight estimation unit specifies, from the first model, the weight coefficient that does not contradict the observed positions and the observed speeds, and estimates the second task weights based on a result of comparison between the specified weight coefficient and the first task weights.

3. The information processing apparatus according to claim 1,
wherein the information processing apparatus is mounted on a specific agent included among the plurality of agents,
the observation unit observes the situations with respect to other agents that are other than the specific agent,
the task weight estimation unit estimates the second task weights with respect to the other agents, and
the task weight update unit updates the first task weights with respect to the other agents.

4. The information processing apparatus according to claim 3, further comprising:
a task assignment unit configured to calculate costs of respective tasks that are executed in the multi-agent system, and assist a task to the specific agent based on each cost calculated and the second task weights that have been estimated with respect to the other agents.

5. The information processing apparatus according to claim 3, further comprising:
a transmission unit configured to transmit the updated first task weights to the other agents;
a reception unit configured to receive the updated first task weights from the other agents; and
a weight combination unit configured to, with use of the updated first weights that have been received, combine the first task weights for each of the other agents,
wherein
using the combined first weights, the task weight estimation means estimates the second task weights with respect to the other agents.

6. An information processing method for assisting assignment of tasks to a plurality of agents in a multi-agent system in which the agents are caused to operate, the information processing method comprising:
observing situations of the agents, including positions and speeds of the agents;
estimating second task weights with reference to a first model based on the observed positions, the observed speeds, and first task weights, the first task weights indicating set values of execution probabilities of tasks by the agents, the second task weights indicating execution probabilities of the tasks by the agents under the observed situations; and
updating the first task weights by inputting the observed positions, the observed speeds, and the estimated second task weights to a second model,
wherein
the first model is a model that, when one of a position and a speed has been input together with a weight coefficient, outputs the other of the position and the speed, and
the second model is a model that increases a value of a first weight as a cost calculated using a position, a speed, and a second task weight decreases.

7. A non-transitory computer readable recording medium that includes a program recorded thereon, the program being intended to cause a computer to assist assignment of tasks to a plurality of agents in a multi-agent system in which the agents are caused to operate,
wherein the recorded program includes instructions that cause the computer to
observe situations of the agents, including positions and speeds of the agents,
estimate second task weights with reference to a first model based on the observed positions, the observed speeds, and first task weights, the first task weights indicating set values of execution probabilities of tasks by the agents, the second task weights indicating execution probabilities of the tasks by the agents under the observed situations, and
update the first task weights by inputting the observed positions, the observed speeds, and the estimated second task weights to a second model,
the first model is a model that, when one of a position and a speed has been input together with a weight coefficient, outputs the other of the position and the speed, and
the second model is a model that increases a value of a first weight as a cost calculated using a position, a speed, and a second task weight decreases.

8. The information processing method according to claim 6,
Wherein, in the task weight estimating, specifying, from the first model, the weight coefficient that does not contradict the observed positions and the observed speeds, and estimating the second task weights based on a result of comparison between the specified weight coefficient and the first task weights.

9. The information processing method according to claim 6,
wherein the information processing method is executed on a specific agent included among the plurality of agents,
in the observing, observing the situations with respect to other agents that are other than the specific agent,
in the task weight estimating, estimating the second task weights with respect to the other agents, and
in the task weight updating, updating the first task weights with respect to the other agents.

10. The information processing method according to claim 9, further comprising:
calculating costs of respective tasks that are executed in the multi-agent system, and assisting a task to the specific agent based on each cost calculated and the second task weights that have been estimated with respect to the other agents.

11. The information processing method according to claim 9, further comprising:
transmitting the updated first task weights to the other agents;
receiving the updated first task weights from the other agents; and
with use of the updated first weights that have been received, combining the first task weights for each of the other agents,
wherein
using the combined first weights, the task weight estimation means estimates the second task weights with respect to the other agents.

12. The non-transitory computer readable recording medium according to claim 7,
Wherein, in the task weight estimating, specifying, from the first model, the weight coefficient that does not contradict the observed positions and the observed speeds, and estimating the second task weights based on a result of comparison between the specified weight coefficient and the first task weights.

13. The non-transitory computer readable recording medium according to claim 7,
wherein the computer is mounted on a specific agent included among the plurality of agents,
in the observing, observing the situations with respect to other agents that are other than the specific agent,
in the task weight estimating, estimating the second task weights with respect to the other agents, and
in the task weight updating, updating the first task weights with respect to the other agents.

14. The non-transitory computer readable recording medium according to claim 13, wherein, the recorded program includes further instructions that cause the computer to:
calculate costs of respective tasks that are executed in the multi-agent system, and assisting a task to the specific agent based on each cost calculated and the second task weights that have been estimated with respect to the other agents.

15. The non-transitory computer readable recording medium according to claim 13, wherein, the recorded program includes further instructions that cause the computer to:
transmit the updated first task weights to the other agents;
receive the updated first task weights from the other agents; and
with use of the updated first weights that have been received, combine the first task weights for each of the other agents,
wherein
using the combined first weights, the task weight estimation means estimates the second task weights with respect to the other agents.
